(19) United States
(12) Patent Application Publication
(10) Pub. No.: US 2011/0283926 A1
(43) Pub. Date: Nov. 24, 2011

(54) METHOD FOR GENERATING PROCESS STEAM

(75) Inventor: Hans-Joachim Klutz, Erftstadt (DE)

(73) Assignee: RWE POWER AKTIENGESELLSCHAFT, Essen (DE)

(21) Appl. No.: 13/130,978

(22) PCT Filed: Nov. 24, 2008
(86) PCT No.: PCT/EP08/09923

§ 371 Date: Aug. 15, 2011

(51) Int. Cl. F26B 3/02

(52) U.S. Cl. 110/218

(57) ABSTRACT

The invention relates to a method for generating process steam by burning dried lignite in a steam generator, comprising the drying of moist lignite in a fluidized bed dryer (1) with internal heat exchanger units (2) through which a heating medium flows, wherein at least some of the water is driven out of the lignite and removed from the dryer as vapors, dust is removed from the vapors in a dedusting device and the dried lignite is cooled in at least one cooler (6) arranged downstream of the fluidized bed dryer (1). The method according to the invention is distinguished by the fact that the brown coal dust occurring in the dedusting device is brought into direct contact with the dried and cooled lignite.

The invention relates to a method for generating process steam by burning dried lignite in a steam generator, comprising the drying of moist lignite in a fluidized bed dryer with internal heat exchanger units through which a heating medium flows, wherein at least some of the water is driven out of the lignite and removed from the dryer as vapors, dust is removed from the vapors in a dedusting device and the dried lignite is cooled in at least one cooler arranged downstream of the fluidized bed dryer.

Such a method is known for example from DE 195 18 644 A1.

According to DE 195 18 644, for drying the pit-wet lignite prior to burning in a steam generator, a fluidized bed dryer is provided, within which the lignite is heated by means of a shell-and-tube heat exchanger, the outer walls of which are in contact with the lignite for a heat exchange. At least one partial stream of the vapors discharged from the fluidized bed dryer is compressed and fed to the heat exchanger as a heating medium, the vapors at least partially condensing. Dust is removed from the vapors extracted from the dryer in an electrostatic filter and burned in the steam generator after cooling. The dried lignite is fed from the dryer to a cooler, to which cooling air is directly applied. The cooled lignite is subsequently ground and burned within the steam generator in the form of lignite dust.

The dry coal discharged from the dryer may have a grain size of about 0.4 to 2 mm. This can be dried in a cascade cooler, as described, for example, in DE 195 37 050 A1. Alternatively, the lignite extracted from the dryer may be cooled in a fluid bed cooler in which the cooling takes place by direct contact with a cold gas, for example with air.

The filter dust retained from the vapor by means of a solids separator, for example by means of an electrostatic filter, has an average grain size of less than 100 μm, with the result that it would be discharged to the greatest extent when it flows through a cascade cooler or fixed bed cooler on account of the very low particle settling rate and the required large amounts of cooling gas. Therefore, the cooler described in DE 195 37 050 A1, for example, is not suitable for cooling filter dusts.

Therefore, indirectly operating coolers are more suitable for the cooling of filter dust. However, the use of such coolers in connection with steam drying methods is less suitable, since the evaporation and condensation of water occurs at the transition from the steam atmosphere to the air atmosphere because of the lower water vapor partial pressure prevailing in the air atmosphere. In particular, the condensation of steam leakages from the dryer discharge causes soiling of the cooling surfaces of such an indirectly operating dryer, with the result that the cooler would lose efficiency relatively quickly.

The invention is therefore based on the object of improving the method according to the invention with regard to the cooling of fine lignite dust.

The object is achieved firstly by a method for generating process steam by burning dried lignite in a steam generator, comprising the drying of moist lignite in a fluidized bed dryer with internal heat exchanger units through which a heating medium flows, wherein at least some of the water is driven out of the lignite and removed from the dryer as vapors, dust is removed from the vapors in a dedusting device and the dried lignite is cooled in at least one cooler arranged downstream of the fluidized bed dryer, the method being distinguished by the fact that the lignite dust occurring in the dedusting device is arranged in layers or mixed in direct contact with the dried and cooled lignite, whereby the cooled lignite is used as cooling medium in a cooler for brown coal dust.

The invention can be summarized to the extent that the already dried and cooled lignite with a grain diameter of 0 to 2 mm is used in an advantageous way as a cooling medium for cooling the filter dust.

It is particularly advantageous if the layering takes place during the transport of the cooled lignite.

The mixing may also take place during the transport of the layered streams of material. In the case of such a procedure, cooling with air may be simultaneously provided following re-evaporation.

It is particularly advantageous if at least three levels of cooled lignite and lignite dust are arranged in layers, wherein cooled lignite and lignite dust are alternately poured one on top of the other. Subsequent intimate mixing of the layers ensures a good heat exchange.

The cooled lignite and the lignite dust are expediently charged one after the other to an endless conveying means, preferably in the form of a trough chain conveyor.

For example, the levels of material comprising lignite dust and cooled lignite may be mixed with one another during transport by means of stationary mixing devices.

The object on which the invention is based is also achieved by an apparatus for cooling lignite dust by the method described above, comprising an encapsulated conveying device with at least two feed devices arranged spaced apart one behind the other in the conveying direction and at least one material discharge, wherein the feed devices are arranged in such a way that streams of material at different temperatures can be charged level by level to the conveying device.

An endless conveying means arranged in a housing may be provided, for example, as the conveying device.

It is particularly advantageous if at least one mixing device arranged in a stationary manner with respect to the conveying device is provided.

Stationary internal mixing elements may be arranged in the housing as the mixing device.

A trough chain conveyor which circulates in an encapsulated housing is expediently provided as the conveying device.

Flow obstacles which are arranged in such a way that they enter the conveyed material and bring about thorough mixing of the material may be provided as internal mixing elements. These internal elements may be formed, for example, in the manner of plowshares which protrude into the loading cross section of the conveyor.

The trough chain conveyor according to the invention may, for example, additionally have cold or preheated air flowing through it, thereby bringing about further cooling of the conveyed stream of material in an advantageous way, primarily after re-evaporation, and preventing the formation of condensate.

The invention is explained below on the basis of an exemplary embodiment that is represented in the drawings, in which

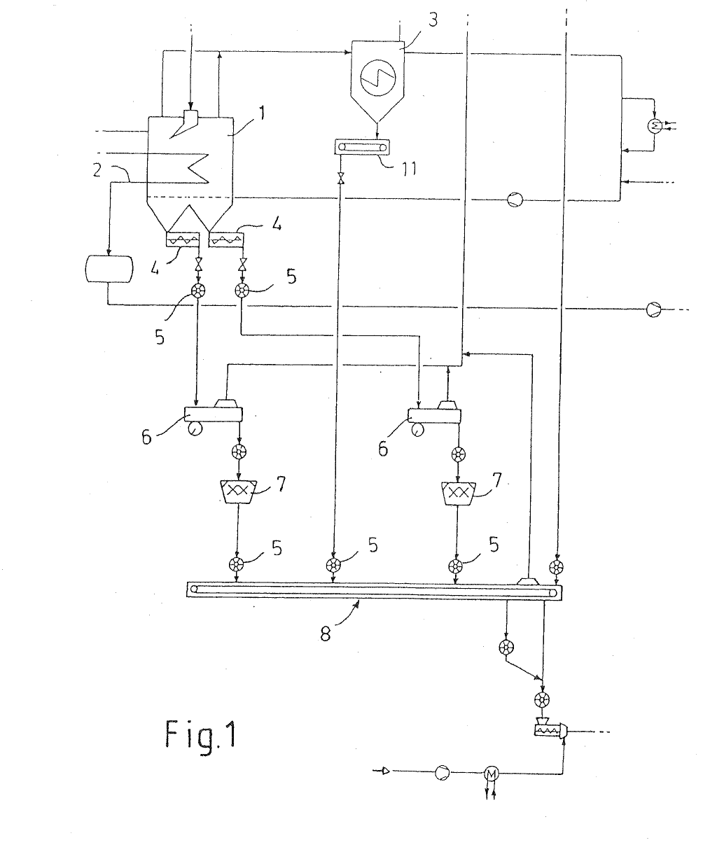

FIG. 1 shows a flow diagram of part of a steam generating process comprising the drying of lignite,

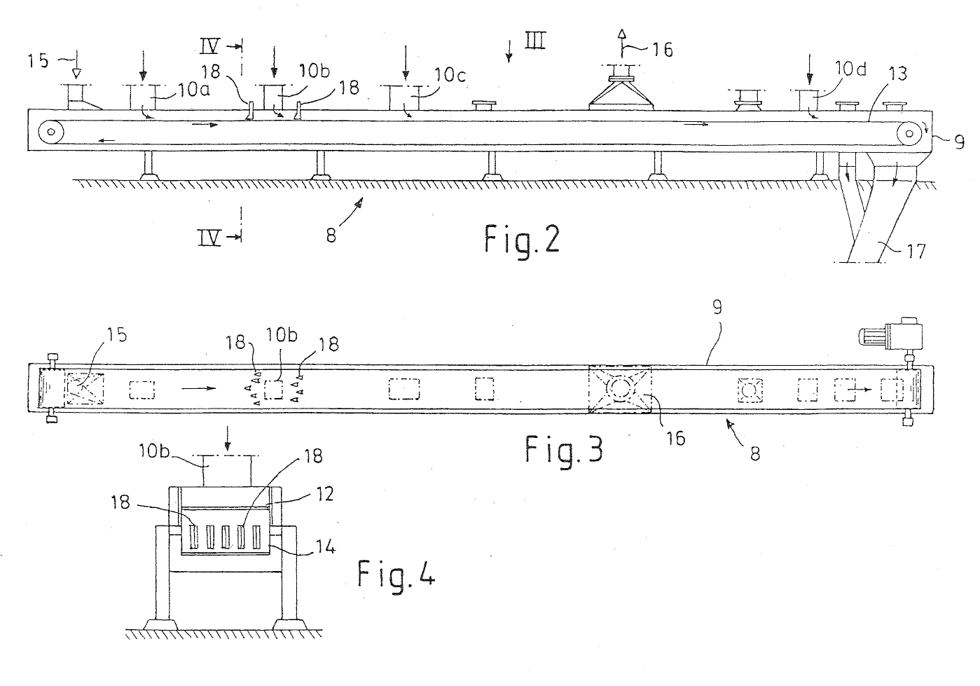

FIG. 2 shows a schematic view of a cooler according to the invention,

FIG. 3 shows a plan view of the cooler according to the invention and

FIG. 4 shows a section through the cooler along the lines IV-IV in FIG. 2.

Reference is first made to FIG. 1. FIG. 1 represents part of a steam generating process. Crude lignite extracted from an opencast mine is first crushed and fed to a multistage fine-grain treatment. The lignite from the fine-grain treatment with an average grain diameter of 0 to 2 mm and a water content of approximately 55 to 65% is subsequently fed to a fluidized bed dryer 1. In the fluidized bed dryer 1, the coal is dried outside the burning process to a residual moisture of approximately 12%, if necessary is ground once again and is burned in a boiler (not represented) for the purpose of steam generation. The steam is expanded in a known way in steam turbines for the purpose of power generation. As already mentioned above, the fluidized bed dryer 1 serves for the drying of the pit-wet lignite, which comes into direct contact with the heat exchanger 2 arranged within the fluidized bed dryer 1. A shell-and-tube heat exchanger may be provided, for example, as the heat exchanger, the outer wall of which comes into contact with the lignite for a heat exchange. Compressed vapors may flow through the heat exchanger 2 or a further heat exchanger, as described, for example, in DE195 18 644 A1.

Dust is removed from the vapors extracted from the fluidized bed reactor 1 in an electrostatic filter. At least a partial amount of the vapors may, for example, be re-compressed and used for heating the fluidized bed dryer 1.

The dried lignite occurring in the fluidized bed dryer 1 is charged to two fluid bed coolers (6), operated in parallel, by way of two worm conveyors (4) and downstream cellular wheel metering devices (5). The dry lignite discharged from the fluid bed coolers (6) is respectively subjected to re-grinding in a downstream dry lignite mill (7) and fed to the cooler (8) according to the invention by way of a further cellular wheel metering device (5).

As further revealed by the flow diagram, the already dried, cooled and re-ground lignite is charged at two points of the cooler (8) arranged spaced apart from one another, to be precise as a cooling medium. The cooler (8) is formed as an encapsulated trough chain conveyor through which air flows. The housing (9) of the cooler (8) is provided altogether with three feed devices 10a, b and c arranged spaced apart one behind the other in the conveying direction, wherein a first upstream feed device is denoted by 10a, a second feed device, arranged downstream thereof, is denoted by 10b and a third feed device, arranged downstream of the second feed device 10b, is denoted by 10c.

The streams of material are charged level by level to the cooler (8) by way of the feed devices 10a, 10b and 10c arranged one after the other, wherein dried and cooled lignite is fed in by way of the first feed device 10a, non-cooled lignite dust is fed in by way of the second feed device 10b and dried, cooled lignite is fed in by way of the third feed device 10c.

Lignite dust is extracted from the electrostatic filter (3) by way of a discharge conveyor (11) and fed to the cooler (8) by way of a cellular wheel metering device (5) and the second feed device (10b).

The conveying direction prevailing in the upper strand (12) of the trough chain conveyor formed as a cooler (8) is represented from the left to the right in FIG. 1, and similarly in FIG. 2, where the conveying device or the direction of rotation is represented by means of arrows.

Reference is made hereafter to FIGS. 2 to 4, from which the detailed structure of the cooler (8) can be seen.

The cooler (8) comprises a substantially closed housing (9) with a circulating conveying chain (13). A trough-shaped upper strand (12) and a trough-shaped lower strand (14) are provided within the housing (9).

Furthermore, an air inlet (15) and an air outlet (16) are provided on the housing (9). In the conveying direction of the conveying chain (13), first an air inlet (15) for cooling air is provided in the lower strand (from left to right in FIG. 2). Downstream of the air inlet (15), the first, second and third feed devices (10a, 10b and 10c) are provided spaced part one behind the other, each in the form of a feed chute. The air outlet (16) in the form of an extractor hood is arranged downstream behind the third feed device. Following downstream thereafter is an optionally provided fourth feed device 10d.

The feed chute of the cooler (8) is denoted by (17).

Cooled, dried and granular lignite, then lignite dust and then downstream once again cooled, dried, granular lignite are alternately charged level by level to the cooler (8). The dried, cooled lignite leaves the fluid bed cooler (6) at a temperature of approximately 30-50° C. The lignite dust leaves the electrostatic filter (3) at a temperature of approximately 105-120° C.

The level-by-level pouring in of the streams of material at different temperatures has the effect of inducing a heat exchange, which ultimately brings about cooling of the filter dust to a temperature of less than 80° C. This temperature is regarded as critical in view of the spontaneous combustion tendency of the lignite dust.

Air at a temperature of approximately 20-40° C. is drawn into the housing (9), which is under slight negative pressure (about 1-20 mbar) by way of the air outlet (16) and the air inlet (15). As a result, any moisture that is released can be absorbed by re-evaporation of the coal water, in order to avoid condensation on the inner side of the housing (9).

To avoid the formation of condensate, it may additionally be envisaged to insulate housing (9).

Mixing devices which are fixedly installed within the housing (9), enter the conveying cross section of the upper strand (12) and bring about mixing of the streams of material are denoted by 18.

In the drawing, the internal mixing elements (18) are respectively arranged upstream and downstream of the second feed device 10b in the upper strand (12) of the cooler (8). However, such internal mixing elements (18) may also be provided at any other point downstream. The internal mixing elements (18) may be formed, for example, as tines which have the geometry of plowshares.

The solution according to the invention has the advantage has the advantage in technical plant-related terms that the cooling of the warm fine lignite dust takes place in a conveying system that is generally required in any case for reasons of plant technology.

The cooling takes place particularly intensively, since the warm dust is embedded and mixed between two cold layers of cooled lignite. The rapid cooling and the intense mixing are assisted by the fixed or static internal mixing elements (18). The mixing of the warm dust with the cooled lignite also has the advantage that discharge of dust is reliably prevented.

### List of Designations

1 fluidized bed dryer
2 heat exchanger
3 electrostatic filter
4 worm conveyor
5 cellular wheel metering device
6 fluid bed cooler
7 dry lignite mills
8 cooler
9 housing
10a, 10b, 10c, 10d first, second, third and fourth feed devices
11 discharge conveyor
12 upper strand
13 conveying chain
14 lower strand
15 air inlet
16 air outlet
17 discharge chute
18 internal mixing elements

1-14. (canceled)

15. A method for generating process steam by burning dried lignite in a steam generator, comprising the drying of moist lignite in a fluidized bed dryer with internal heat exchanger units through which a heating medium flows, wherein at least some of the water is driven out of the lignite and removed from the dryer as vapors, dust is removed from the vapors in a dedusting device and the dried lignite is cooled in at least one cooler arranged downstream of the fluidized bed dryer, characterized in that the brown coal dust occurring in the dedusting device is arranged in layers or mixed in direct contact with the dried and cooled lignite, whereby the cooled lignite is used as cooling medium in a cooler for brown coal dust.

16. The method as claimed in claim 15, characterized in that the layering takes place during the transport of the cooled lignite.

17. The method as claimed in either of claim 15, characterized in that the mixing takes place during the transport of the layered streams of material.

18. The method as claimed in one of claim 15, characterized in that at least altogether three layers of cooled lignite and lignite dust are arranged in layers, wherein cooled lignite and lignite dust are alternatively poured one on top of the other.

19. The method as claimed in one of claim 15, characterized in that cooled lignite and lignite dust are charged one behind the other to an endless conveying means, preferably in the form of a trough chain conveyor.

20. The method as claimed in claim 19, characterized in that the levels of material comprising cooled lignite and lignite dust are mixed with one another during transport by means of stationary mixing devices.

21. An apparatus for cooling lignite by the method according to claim 15, comprising as cooler an encapsulated conveying device with at least two feed devices arranged spaced apart one behind the other in the conveying direction and at least one material discharge, wherein the feed devices are arranged in such a way that streams of material at different temperatures can be charged level by level to the conveying device.

22. The apparatus as claimed in claim 21, characterized in that an endless conveying means arranged in a housing is provided as the conveying device.

23. The apparatus as claimed in either of claim 21, characterized in that at least one mixing device arranged in a stationary manner with respect to the conveying device is provided.

24. The apparatus as claimed in claims 22, characterized in that the stationary internal mixing elements are arranged in the housing as the mixing device.

25. The apparatus as claimed in claim 21, characterized in that a trough chain conveyor is provided as the conveying device.

26. The apparatus as claimed in claim 24, characterized in that flow obstacles which are arranged in such a way that they enter the conveyed material and bring about thorough mixing of the material are provided as internal mixing elements.
